(19) United States
(12) Patent Application Publication
(10) Pub. No.: US 2015/0169607 A1
(43) Pub. Date: Jun. 18, 2015

(54) SYSTEMS AND METHODS TO PRESENT IMAGES REPRESENTATIVE OF SEARCHED ITEMS

(71) Applicant: eBay Inc., San Jose, CA (US)

(72) Inventors: Noah Howard Batterson, Saratoga, CA (US); Yoni Medoff, San Jose, CA (US)

(21) Appl. No.: 14/108,550

(22) Filed: Dec. 17, 2013

(51) Int. Cl. G06F 17/30

(52) U.S. Cl. CPC G06F 17/30112

(57) ABSTRACT

A request that identifies a plurality of items may be received from a device operated by a user. A plurality of view item pages may be accessed. The plurality of view item pages may be accessed based on the plurality of items that were identified in the request. An interface that includes a plurality of images respectively representative of the plurality of items may be generated. The generation of the interface may utilize the accessed plurality of view item pages that correspond to the plurality of items that were identified in the request. Lastly, the interface that includes the plurality of images representative of the plurality of items may be presented to the device operated by the user.

### TECHNICAL FIELD

This application relates generally to data processing within a network-based system operating over a distributed network, and more specifically to systems and methods to present images representative of searched items.

### BACKGROUND

A user may browse items online by providing a search query. The search query may return a list of items that are presented to the user. From the list of items, the user may navigate to an item page of an item that includes an image of the item.

### BRIEF DESCRIPTION OF THE DRAWINGS

Some embodiments are illustrated by way of example and not limitation in the figures of the accompanying drawings in which:

FIG. 1 is a network diagram illustrating a network environment suitable to present images representative of searched items, according to an example embodiment;

FIG. 2 is a block diagram illustrating an image machine, according to an example embodiment;

FIGS. 3-5 are diagrams illustrating an example user interface, according to an example embodiment, displaying images that are representative of a plurality of items;

FIG. 6 is a block diagram illustrating a method to present a plurality of images representative of view item pages, according to an example embodiment; and

FIG. 7 is a diagrammatic representation of a machine in the example form of a computer system within which a set of instructions for causing the machine to perform any one or more of the methodologies discussed herein may be executed.

### DETAILED DESCRIPTION

A user may search for items by providing a search query. The search query may be executed to retrieve item pages that illustrate and describe the items. Moreover, images representative of the items may be presented by a publication server to the user, allowing the user to preview the images of the items before conducting a search using the search query. The publication server may also present symbols depicting user activity with respect to the item pages of the items.

Example methods and systems are directed to present images representative of searched items. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

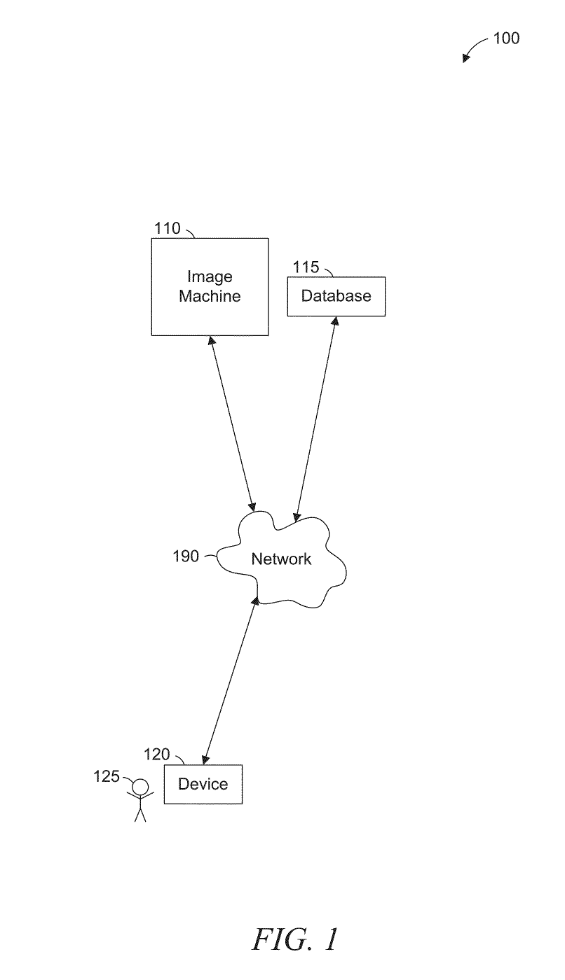

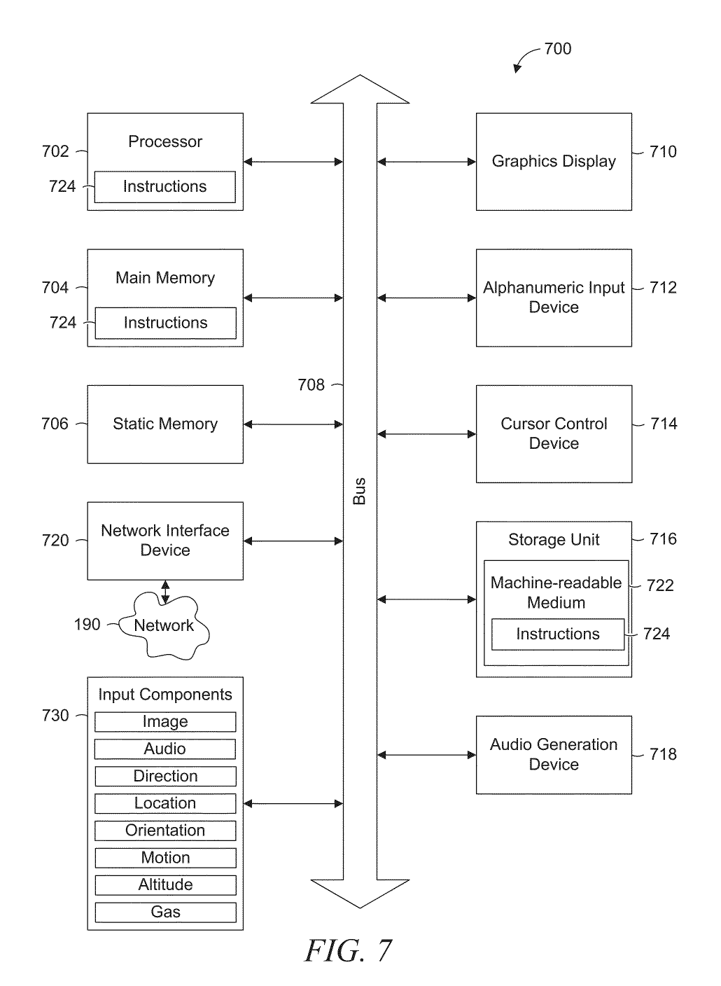

FIG. 1 is a network diagram illustrating a network environment 100 suitable to present images representative of searched items, according to an example embodiment. The network environment 100 includes an image machine 110, a database 115, and device 120, all communicatively coupled to each other via a network 190. The image machine 110 and the device 120 may each be implemented in a computer system, in whole or in part, as described below with respect to FIG. 7.

Also shown in FIG. 1 is user 125 who may be human (e.g., a human being), a machine (e.g., a computer configured by a software program to interact with the device 120), or any suitable combination thereof (e.g., a human assisted by a machine or a machine supervised by a human). The user 125 is not part of the network environment 100, but is associated with the device 120 and may use the device 120. For example, the device 120 may be a desktop computer, a vehicle computer, a tablet computer, a navigational device, a portable media device, or a smart phone belonging to the user 125.

In various embodiments, the user 125 may search for items online. The user 125 may submit search criteria via the device 120 to the image machine 110. In response to receiving the search criteria from the user 125, the image machine may access view item pages of the searched items from the database 115. Moreover, the image machine 110 may generate images of searched items that are displayed on the device 120 that is being operated by the user 125. In various embodiments, the images may be representative of the searched items. The images representative of the searched items may be displayed by the image machine 110 on a single page in the device 120. This may allow the user 125 to view all the images representative of the searched items at once.

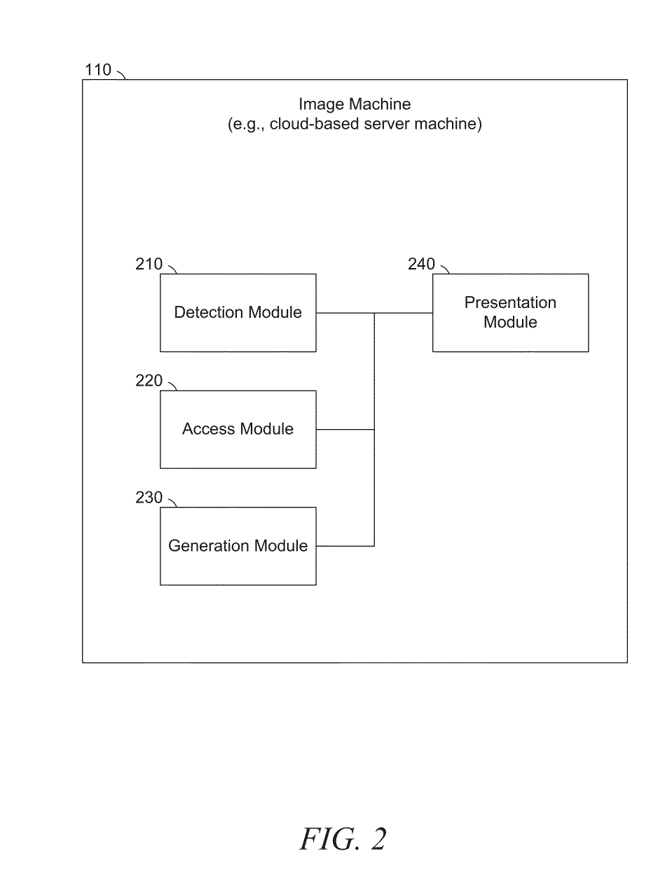

FIG. 2 is a block diagram illustrating the image machine 110, according to an example embodiment. The image machine may include a detection module 210, an access module 220, a generation module 230, and a presentation module 240.

In various embodiments, the detection module 210 may be configured to receive a request that identifies a plurality of items. The request may be received from a device (e.g., device 120) operated by a user (e.g., user 125). In various embodiments, the detection module 210 may be further configured to receive search criteria that are used to identify one or more items in a database. The search criteria may match with descriptions of the plurality of items. For instance, the detection module 210 may receive the request that includes an item identifier that references the plurality of items. Each of the plurality of items may be respectively viewed by a user on the device 120 (as shown in FIG. 1) via an interface (e.g., user interface) in the form of a view item page that is communicated over the network 190 to the device 120 where it is visually displayed to the user 125. The view item page may include a description of an item, an image of an item, and a control that is operable to purchase the item.

In various embodiments, the access module 220 may access the view item pages corresponding to the plurality of items identified in the request received at the detection module 210 from the device 120 that is being operated by the user. The access module 220 may access the view item pages of the plurality of items based on the search criteria received at the detection module 210. The view item pages of the plurality of items may be stored in memory available to be accessed from a database (e.g., database 115). Moreover, the view item pages of the plurality of items may be previously generated by the generation module 230 prior to receiving any request from the device (e.g., device 120) operated by the user (e.g., user 125). The search criteria may match with descriptions of the view item page of the plurality of items. In various embodiments, the view item pages accessed by the access module 220 may also include descriptions absent from the search criteria included in the request. For instance, the request may include search criteria describing a “BMX bike” and the access module 220 may access view item pages of “BMX bike tires”, “BMX bike helmet”, “BMX bike gear”, and the like.

In various embodiments, the access module 220 may be further configured to access preferences of the user. The preferences of the user may be accessed by the access module 220 from a user profile stored in a database (e.g., database 115). The preferences of the user may reflect decisions the user made on previous occasions (e.g., the user has browsed for items in a specific category, items of a specific brand, and the like). As a result, the presentation module 240 may present the interface that includes plurality of images representative of the plurality of items based on the preferences of the user accessed by the access module 220. For instance, the presentation module 240 may only present images representative of view item pages falling in the specific category the user browsed on the previous occasions.

In various embodiments, the generation module 230 may generate an interface that includes a plurality of images that are respectively representative of the plurality of items. The generation module 230 may generate the interface by utilizing the plurality of view item pages accessed by the access module 220. The generation module 230 may generate the interface that includes the plurality of images representative of the plurality of items by retrieving images of the plurality of items from the view item pages of the plurality of items. In various embodiments, the generation module 230 may generate the plurality of images representative of the plurality of items based on the retrieved images of the plurality of items from the view item pages. In other words, the each of the generated plurality of images may respectively represent each of the plurality of items. Moreover, each of the generated plurality of images may be generated based on a retrieved image of an item among the plurality of items. In various embodiments, the generation module 230 may generate the plurality of images by identifying image characteristics from the retrieved images of the plurality of items. The identified image characteristics may include color of the image, size of the image, orientation of the image, and the like. Once identified, the generation module 230 may generate the plurality of images representative of the plurality of items based on the identified image characteristics from the retrieved images of the plurality of items. In various embodiments, the generation module 230 may modify the image characteristics from the retrieved images of the plurality of items. Moreover, the images representative of the plurality of items may be generated by the generation module 230 based on the modified image characteristics. Therefore, the generated plurality of images representative of the plurality of items may be different from the retrieved images of the plurality of items. In some instances, at least one or more of the image characteristics from the retrieved images may be absent or modified in the generated images representative of the plurality of items. For example, the images representative of the plurality of items may be generated in a different color compared to the retrieved images of the plurality of items from the view item pages of the plurality of items. As another example, the images representative of the plurality of items may be generated in a different size compared to the retrieved images of the plurality of items.

In various embodiments, the presentation module 240 may present the interface that includes a plurality of images representative of the plurality of items to the device of the user. The plurality of images representative of the plurality of items may be selectable by the user. The detection module 210 may be further configured to receive a selection of an image included in the generated interface that includes the plurality of images, the image representative of an item among the plurality of items. Moreover, the presentation module 240 may be further configured to present the view item page of the item among the plurality of items based on the selection of the image received at the detection module 210. In various embodiments, the presentation module 240 is further configured to present the descriptions of the plurality of items along with the plurality of images representative of the plurality of items in a single recommendation page which may be viewed by the device operated by the user. The descriptions of the plurality of items may each respectively describe the plurality of images representative of the plurality of items.

In various embodiments, the presentation module 240 may present the interface that includes the plurality of images representative of the plurality of items to the device of the user prior to the presentation module 240 presenting the view item pages of the plurality of items. In this way, the user may not have to browse the view item pages of the one or more items via the device of the user. Instead, the user may view the single recommendation page presented by the presentation module 240 via the device. In various embodiments, the presentation module 240 may present the interface that includes the plurality of images representative of the one or more items to the device of the user prior to receiving an indication from the user to perform a search using the search criteria received at the detection module 250. In other words, the plurality of images may be presented to the user as the user is providing the search criteria via the device of the user. Moreover the presentation module 240 may present the plurality of images on a single display page to allow the user to view all of the plurality of images representative of the plurality of items at once. This may allow the user to make a more efficient decision rather than having to click through each of the view item pages of the plurality of items.

In various embodiments, the detection module 210 may be further configured to determine a quantity of interaction with respect to each of the view item pages of the plurality of items. The quantity of interaction with respect to each of the view item pages may include a number of visitors viewing the view item pages, a number of shoppers purchasing the items from the view item pages, a change in a number of unique visitors viewing the view item pages online, and the like. In various embodiments, the generation module 230 may be further configured to generate a plurality of symbols depicting the determined quantity of interaction with respect to each of the accessed view item pages of the plurality of items. Each symbol among the plurality of symbols may represent a quantity of interaction with respect to a view item page of an item among the plurality of items. Moreover, each symbol may be displayed next to an item description of an item among the plurality of items. In various embodiments, the presentation module 240 may display the generated plurality of symbols in the single recommendation page with the plurality of images representative of the plurality of items. In various embodiments, the presentation module 240 may display a symbol among the plurality of symbols next to an image among the plurality of images. In various embodiments, the generation module 230 may be further configured to generate a plurality of symbols indicating the number of items available from each of the view item pages. In various embodiments, the presentation module 240 may be further configured to sort the plurality of images based on the quantity of interaction with respect to each of the view item pages of the plurality of items, as determined by the detection module 210. In other words, each image representative of an item among the plurality of images may be sorted based on a quantity of interaction with respect to a view item listing of the item represented by the image.

In various embodiments, the detection module 210 may be further configured to receive a selection of an image among the plurality of images representative of the plurality of items. In response, the presentation module 240 may highlight the selected image based on the selection of the image received at the detection module 210. The presentation module 240 may highlight the selected image by enlarging the highlighted image, brightening the highlighted image, displaying a border around the highlighted image, and performing a gesture with the highlighted image. In various embodiments, the detection module 210 may receive a selection of a description of an item among the one or more items represented by the plurality of images. The receiving module 250 may receive the selection of the image among the plurality of images based on the selected description of the item.

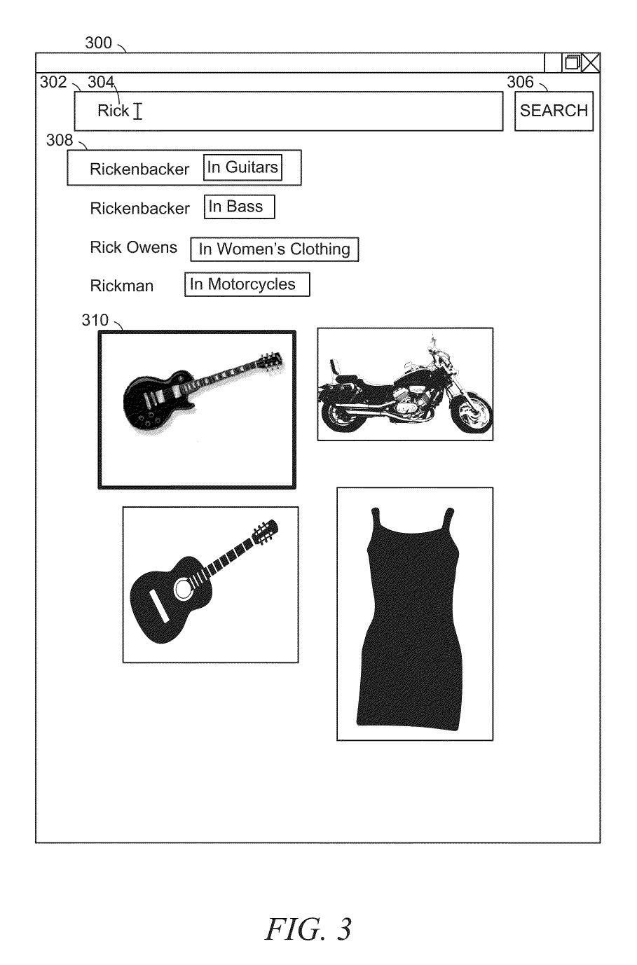

FIG. 3 is a diagram illustrating an example user interface 300, according to an example embodiment, displaying images that are representative of a plurality of items. The user interface 300 may receive search criteria into a search bar 302 from the user. As depicted in FIG. 3, the search criteria entered may be “Rick” 304. Images representative of plurality of items may be retrieved responsive to receipt of the search criteria provided via the search bar 302. In various embodiments, the images representative of the plurality of items may be presented prior to receiving an indication from the user to execute a search using the search criteria in the search bar 302, such as the user clicking on the search button 306. Moreover, the images representative of the plurality of items may be displayed in a generated interface in a single page, as depicted in the user interface 300. In various embodiments, descriptions of the plurality of items may also be displayed in the user interface 300 responsive to receipt of the search criteria and prior to the to receiving the indication from the user to execute the search using the search criteria in the search bar 302. The descriptions of the plurality of items respectively correspond to the multiple images that are being displayed in the user interface 300. Accordingly, in one example, a user may select a description of an item 308 depicted as “Rickenbacker in Guitars” from the descriptions displayed in the user interface 300 thereby causing a corresponding image 310 of the item to be highlighted. In user interface 300, the border around the image 310 is bolded in order to highlight the image 310. Alternatively, the user may select the image 310 and cause the description of the item 308 to be highlighted with a border around the description of the item 308.

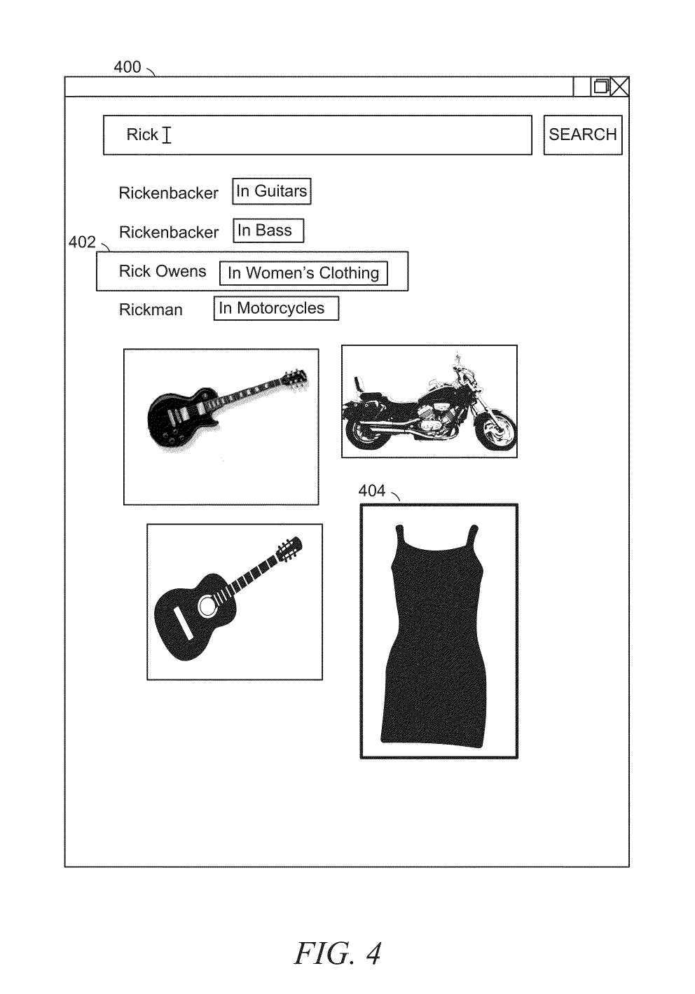

FIG. 4 is a diagram illustrating an example user interface 400, according to an example embodiment, displaying images that are representative of a plurality of items. The user may select a description of a further item 402 among the plurality of items. Selection of the description of the further item 402 may cause an image 404 corresponding to the description of the item to be highlighted. Alternatively, the user may select the image 404 and cause the description of the item 402 to be highlighted with a border around the description of the item 402. Moreover, the image 308 corresponding to the description of the item 306 as depicted in FIG. 3 may no longer be highlighted.

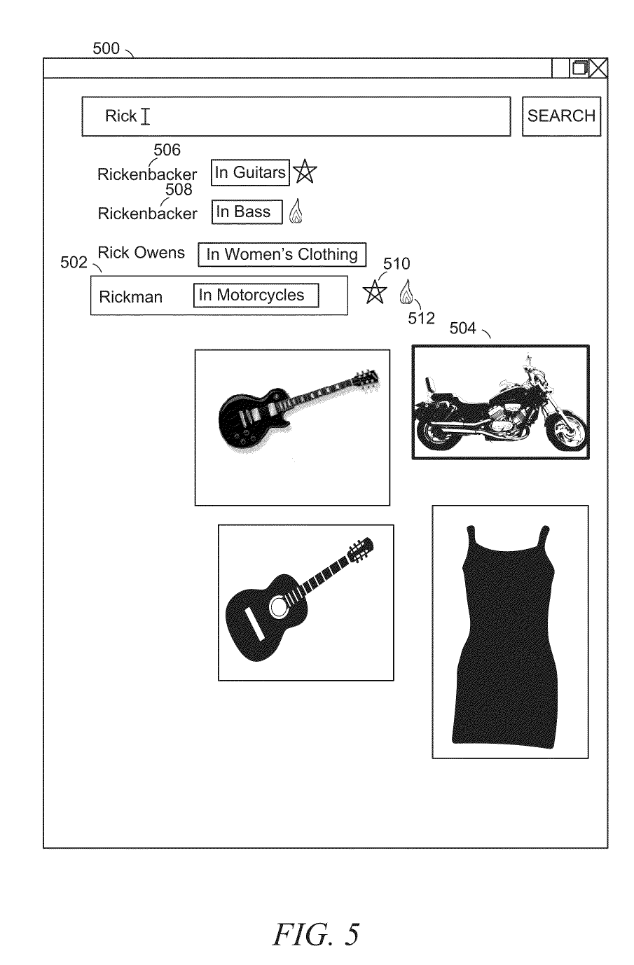

FIG. 5 is a diagram illustrating an example user interface 500, according to an example embodiment, displaying images that are representative of a plurality of items. The user may select a description of a further item 506 among the plurality of items. Selection of the description of the further item 502 may cause an image 504 corresponding to the description of the item to be highlighted. Moreover, the image 404 corresponding to the description of the item 402, as depicted in FIG. 4, may no longer be highlighted. Next to the description of the further item 502 may be a first symbol 510 (e.g., star) and a second symbol 512 (e.g., flame). The first symbol 510 may depict a quantity of interaction with respect to the view item page of the further item. The second symbol 512 may also depict a quantity of interaction with respect to the view item page of the further item. The first symbol 510, which is a star, may signal a number of shoppers purchasing the items from the view item page of the further item. For example, the star may indicate that at least 5000 shoppers are purchasing items from the view item page of the further item. The second symbol 512, which is a flame, may depict change in a number of unique visitors viewing the view item page of the further item. For example, the flame may indicate that at least 1000 users have visited the view item page of the further item within the last 10 minutes. Moreover, the first symbol may also be displayed next to descriptions of other items. For instance, the first symbol is also displayed next to the “Rickenbacker in Guitars” description 506. The first symbol may indicate that at least 5000 shoppers are purchasing items described as “Rickenbacker in Guitars.” Moreover, the second symbol is also displayed next to the “Rickenbacker in Bass” description 508. The second symbol may indicate that at least 1000 users have visited the view item page of the item described as “Rickenbacker in Bass.”

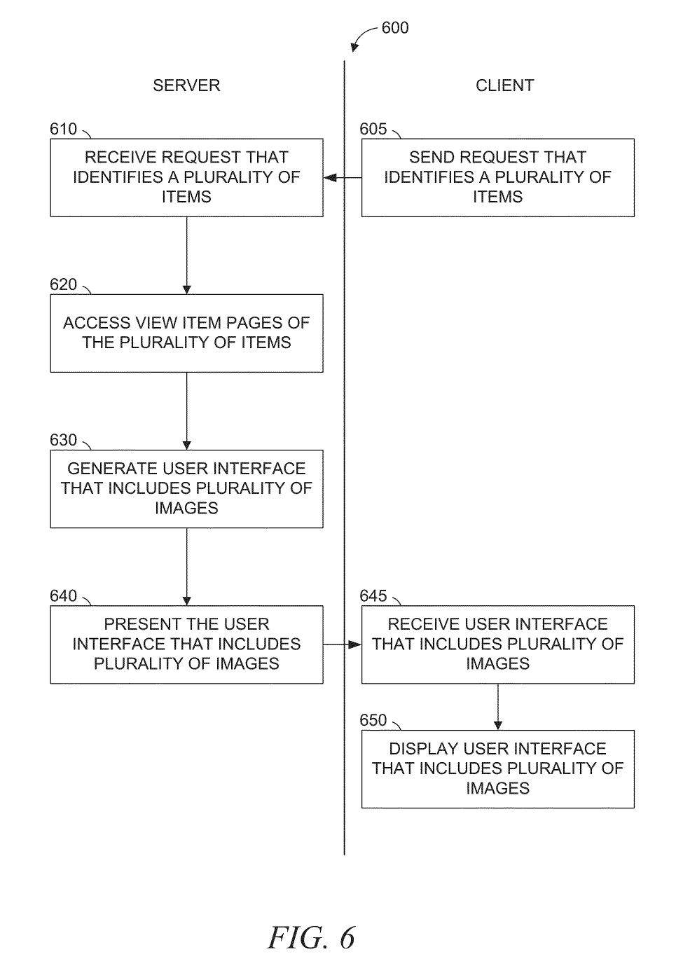

FIG. 6 is a block diagram illustrating a method 600 to present a plurality of images representative of view item pages, according to an example embodiment.

At step 605, a device 120 that is being operated by a user may send a request that identifies a plurality of items.

At step 610, the detection module 210 may receive the request that identifies a plurality of items, the request being received at the image machine 110 from over the network 190 from the device 120 that is being operated by the user. At step 620, at the image machine 110, the access module 220 may access view item pages of the plurality of items that are identified by the request received at the detection module 210 from the device 120 that is operated by the user 125. At step 630, the generation module 230 may generate a user interface 300 that includes a plurality of images that are representative of the plurality of items that were identified in the request. The generation module 230 may generate the user interface 300 based on the view item pages that were accessed by the access module 220. At step 640, the presentation module 240 may communicate the user interface 300 over the network 190 to the device 120 to utilize the user interface to present the plurality of images representative of the plurality of items to the user 125.

At step 645, the device 120 may receive the user interface that includes the plurality of images representative of the plurality of items from the presentation module 240. At step 650, at the device 120, the user interface 300 (as shown in FIG. 3) may be displayed on the device 120 to the user (e.g., user 125). In other examples, the user interface 400 (as shown in FIG. 4) and 500 (as shown in FIG. 5) may be displayed on the device 120 to the user (e.g., user 125).

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 16. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

FIG. 7 is a block diagram illustrating components of a machine 700, according to some example embodiments, able to read instructions 724 from a machine-readable medium 722 (e.g., a machine-readable storage medium, a computer-readable storage medium, or any suitable combination thereof) and perform any one or more of the methodologies discussed herein, in whole or in part. Specifically, FIG. 7 shows the machine 700 in the example form of a computer system within which the instructions 724 (e.g., software, a program, an application, an applet, an app, or other executable code) for causing the machine 700 to perform any one or more of the methodologies discussed herein may be executed, in whole or in part. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, an audio generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media (e.g., tangible and non-transitory machine-readable media). The instructions 724 may be transmitted or received over the network 190 via the network interface device 720. For example, the network interface device 720 may communicate the instructions 724 using any one or more transfer protocols (e.g., hypertext transfer protocol (HTTP)).

In some example embodiments, the machine 700 may be a portable computing device, such as a smart phone or tablet computer, and have one or more additional input components 730 (e.g., sensors or gauges). Examples of such input components 730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a request that identifies a plurality of items, the request being received from a device that is operated by a user;
accessing a plurality of view item pages based on the plurality of items that were identified in the request received from the device operated by the user, the accessing being performed in response to the request received;
generating an interface that includes a plurality of images that are respectively representative of the plurality of items, the generating the interface utilizing the accessed plurality of view item pages that correspond to the plurality of items that were identified in the request; and
presenting the interface that includes the plurality of images representative of the plurality of items to the device of the user, the plurality of images being selectable by the user to browse the plurality of view item pages that correspond to the plurality of the items identified in the received request.

2. The method of claim 1, further comprising:
determining a quantity of interaction with respect to each of the accessed plurality of view item pages that correspond to the plurality of items that were identified in the request;
generating a plurality of symbols depicting the quantity of interaction with respect to each of the accessed plurality of view item pages that correspond to the plurality of items that were identified in the request; and
presenting the generated plurality of symbols to the device operated by the user.

3. The method of claim 1, wherein the receiving the request that identifies the plurality of items includes
receiving search criteria that match with descriptions of the plurality of items; and wherein the accessing the plurality of view item pages that correspond to the plurality of items is based on the received search criteria that matches with the descriptions of the plurality of items.

4. The method of claim 1, wherein the accessing the plurality of view item pages includes retrieving images of the plurality of items from the plurality of view item that correspond to the plurality of items, and wherein the generating the interface that includes the plurality of images respectively representative of the plurality of items is based on the images of the plurality of items retrieved from the plurality of view item pages that correspond to the plurality of items.

5. The method of claim 1, further comprising:
receiving a selection of an image included in the generated interface that includes the plurality of images, the image representative of an item among plurality of items; and
presenting a view item page of the item among the plurality of items based on the selection of the image.

6. The method of claim 1, wherein the presenting the interface that includes the plurality of images representative of the plurality of items includes presenting descriptions of the plurality of items depicted in the plurality of images representative of the plurality of items.

7. The method of claim 1, further comprising:
receiving a selection of an image included in the generated interface that includes the plurality of images; and
highlighting the selected image based on the received selection.

8. The method of claim 7, wherein the highlighting the selected image among the plurality of images includes at least one of enlarging the highlighted image, brightening the highlighted image, displaying a border around the highlighted image, and performing a gesture with the highlighted image.

9. The method of claim 2, wherein the quantity of interaction with respect to each of the plurality of view item pages includes at least one of a number of visitors viewing the view item pages, a number of shoppers purchasing the items from the view item pages, a number of items available from each of the view item pages, and a change in a number of unique visitors viewing the view item pages.

10. The method of claim 1, further comprising:
accessing preferences of the user, and wherein
the presenting the interface that includes plurality of images representative of the plurality of items is based the preferences of the user.

11. A system comprising:
a detection module configured to a request that identifies a plurality of items, the request received from a device operated by a user;
an access module configured to access a plurality of view item pages based on the plurality of items that were identified in the request received from the device operated by the user, the access performed in response to the request received;
a generation module configured to:
generate an interface that includes a plurality of images that are respectively representative of the plurality of items; and
utilize the accessed plurality view item pages of the plurality of items that correspond to the plurality of items that were identified in the request; and
a presentation module configured to present the interface that includes the plurality of images representative of the plurality of items to the device of the user, the plurality of images is selectable by the user to browse the plurality of view item pages that correspond to the plurality of items identified by the received request.

12. The system of claim 1, wherein the detection module is further configured to determine a quantity of interaction with respect to each of the accessed plurality of view item pages that correspond to the plurality of items that were identified in the request, and wherein the generation module is further configured to generate a plurality of symbols depicting the quantity of interaction with respect to each of the accessed plurality of view item pages that correspond to the plurality of items that were identified in the request, and wherein the presentation module is further configured to present the generated plurality of symbols to the device operated by the user.

13. The system of claim 1, wherein the detection module is further configured to receive search criteria that match with descriptions of the plurality of items, and wherein the access module is further configured to access the plurality of view item pages that correspond to the plurality of items based on the received search criteria that match with the descriptions of the plurality of items.

14. The system of claim 1, wherein the access module is further configured to retrieve images of the plurality of items from the plurality of view item pages that correspond to the plurality of items, and wherein the generation module is further configured to generate the interface that includes the plurality of images respectively representative of the plurality of items based on the images of the plurality of items retrieved from the plurality of view item pages that correspond to the plurality of items.

15. The system of claim 1, wherein the detection module is further configured to receive a selection of an image included in the generated interface that includes the plurality of images, the image representative of an item among the plurality of items, and wherein the presentation module is further configured to present a view item page of the item among the plurality of items based on the selection of the image.

16. The system of claim 1, wherein the presentation module is further configured to present descriptions of the plurality of items depicted in the plurality of images representative of the plurality of items.

17. The system of claim 1, wherein the detection module is further configured to receive a selection of an image included in the generated interface that includes the plurality of images, and wherein the presentation module is further configured to highlight the selected image based on the received selection.

18. The system of claim 17, wherein the presentation module further configured to perform at least one of enlarging the highlighted image, brightening the highlighted image, displaying a border around the highlighted image, and performing a gesture with the highlighted image.

19. The system of claim 1, wherein the quantity of interaction with respect to each of the plurality of view item pages includes at least one of a number of visitors viewing the view item pages, a number of shoppers purchasing the items from the view item pages, a number of items available from each of the view item pages, and a change in a number of unique visitors viewing the view item pages.

20. A non-transitory machine-readable medium storing instructions which, when executed by one or more processors, cause the one or more processors to perform operations comprising:
receiving a request that identifies a plurality of items, the request being received from a device that is operated by a user;
accessing a plurality of view item pages based on the plurality of items that were identified in the request received from the device operated by the user, the accessing being performed in response to the request received;
generating an interface that includes a plurality of images that are respectively representative of the plurality of items, the generating the interface utilizing the accessed plurality of view item pages that correspond to the plurality of items that were identified in the request; and
presenting the interface that includes the plurality of images representative of the plurality of items to the device of the user, the plurality of images being selectable by the user to browse the plurality of view item pages that correspond to the plurality of the items identified in the received request.
